(19) United States
(12) Patent Application Publication
(10) Pub. No.: US 2004/0238744 A1
(43) Pub. Date: Dec. 2, 2004

(54) Perturbation approach to resonance shift of whispering gallery modes in a dielectric microsphere as a probe of a surrounding medium

(76) Inventors: Stephen Arnold, New York, NY (US); Iwao Teraoka, Rye, NY (US); Frank Vollmer, New York, NY (US)

Correspondence Address: STRAUB & POKOTYLO, 620 TINTON AVENUE, BLDG. B, 2ND FLOOR, TINTON FALLS, NJ, 07724, US

(21) Appl. No.: 10/758,248

(22) Filed: Jan. 15, 2004

Related U.S. Application Data
(60) Provisional application No. 60/440,236, filed on Jan. 15, 2003.

(51) Int. Cl. G01N 21/41

(52) U.S. Cl. 250/341.2

(57) ABSTRACT

A first-order perturbation theory similar to the one widely used in quantum mechanics is developed for transverse-electric and transverse-magnetic photonic resonance modes in a dielectric microsphere. General formulas for the resonance frequency shifts in response to a small change in the exterior refractive index and its radial profile are derived. The formulas are applied to two sensor applications of the microsphere to probe the medium in which the sphere is immersed: a refractive index detector; and a refractive index profile sensor.

### § 0.1 RELATED APPLICATIONS

This application claims benefit to U.S. Provisional Application Ser. No. 60/440,236, titled “Perturbation Approach to Resonance Shift of Whispering Gallery Modes in a Dielectric Microsphere as a Probe of a Surrounding Medium,” filed on Jan. 15, 2003, and listing Stephan Arnold, Iwao Teraoka and Frank Vollmer as inventors (referred to as “the '236 provisional”). That application is incorporated herein by reference. The scope of the present invention is not limited to any requirements of the specific embodiments described in that application.

### § 0.2 FEDERAL FUNDING

This invention was made with Government support and the Government may have certain rights in the invention as provided for by grant number BES0119273 by the National Science Foundation.

### § 1. BACKGROUND OF THE INVENTION

§ 1.1 Field of the Invention

The present invention concerns analysis of chemicals and/or biological materials such as, for example, measurement, detection, etc. In particular, the present invention concerns instrumental analysis of chemicals and/or biological materials.

§ 1.2 Background Information

There are many applications in which chemicals or biological substances need to be analyzed. A wide assortment of instrumentation is available to the analyst. In some cases, the instrument is used to characterize a chemical reaction between the analyte and an added reagent; in others, it is used to measure a property of the analyte. Instrumental analysis is subdivided into categories on the basis of the type of instrumentation employed. Such categories of instrumental analysis include spectral methods, electroanalysis methods, and separatory methods. Each of these methods has limits, such as costs, size, portability, time, sensitivity, etc.

Separatory instruments may use chromatography or mass spectrometry for example. High performance liquid chromatography (HPLC) is a popular method of analysis, and is often used to analyze drugs, foods, beverages, environmental samples, etc. (See, e.g., U.S. Pat. Nos. 3,985,021 and 5,795,469 (both incorporated herein by reference.) Unfortunately, detectors used in liquid chromatography are often bulky.

In view of the foregoing, better methods of instrumental analysis and the associated instrumentation are needed. In the case of liquid chromatography, less bulky, yet accurate, detectors would be desirable.

### § 2. SUMMARY OF THE INVENTION

The present invention provides new methods of instrumental analysis that determine a refractive index, or a refractive index profile, of an analyte. The present invention may make such determinations using a shift in a property of light, such as a wavelength or resonance frequency shift of light in a microsphere, where the microsphere is immersed in the analyte, as in the case HPLC for example.

The present invention also provides examples of instrumentation used to practice such new methods, such as in the context of HPLC for example.

### § 3. BRIEF DESCRIPTION OF THE DRAWINGS

FIG. 1 illustrates sensitivity factors f_{TE} (solid lines) and f_{TM} (dashed lines) of resonance frequency of TE and TM modes, respectively, in a microsphere to a uniform refractive index change in the surrounding medium, plotted as a function of size parameter k₀a. The lines are for the first three orders (n=1, 2, and 3) for m₁=1.47 and m₂=1.33.

FIG. 2 illustrates an expected sensing limit Δm_{2,min} of refractive index change in the surrounding medium in microspheres of different k₀a for the first three modes. Solid lines are from the intrinsic linewidth of resonance. Dashed lines denote the sensing limit for current DFB laser driver's resolution, Δk/k₀=10⁻⁸.

FIG. 3 is a diagram illustrating an exemplary refractive index detector consistent with the present invention.

FIG. 4 is a flow diagram of an exemplary method that may be used to detect a refractive index of an analyte in a manner consistent with the present invention.

FIG. 5 illustrates a refractive index profile across a microsphere-surrounding medium interface.

FIG. 6 illustrates frequency shift due to refractive index change of Δm₂(r)=Δm₂(∞)[1−exp(−Γ(r−α))], reduced by the shift due to a constant Δm₂, as a function of 1/Γ. All the lines share a=100 μm and m₂=1.33. The values of the other parameters are indicated in the legend.

FIG. 7 is a diagram illustrating an exemplary refractive index profile detector consistent with the present invention.

FIG. 8 is a flow diagram of an exemplary method that may be used to determine a refractive index profile of an analyte in a manner consistent with the present invention.

### § 4. DETAILED DESCRIPTION

The following description of embodiments consistent with the principles of the invention provides illustration and description, but is not intended to be exhaustive or to limit the invention to the precise form disclosed. Modifications and variations are possible in light of the following teachings or may be acquired from practice of the invention. For example, although a series of acts may have been described with reference to a flow diagram, the order of acts may differ in other implementations when the performance of one act is not dependent on the completion of another act. Further, non-dependent acts may be performed in parallel.

No element, act or instruction used in the description should be construed as critical or essential to the invention unless explicitly described as such. Also, as used herein, the article “a” is intended to include one or more items. Where only one item is intended, the term “one” or similar language is used.

The present invention may determine a refractive index, or a refractive index profile, of an analyte using a shift in a property of light, such as a wavelength or resonance frequency shift of light in a microsphere, where the microsphere is immersed in the analyte, as in the case HPLC for example. The resonance frequency is sensitive to the environment in close vicinity of the sphere surface. Any change in the vicinity can be detected as a frequency shift. The changes will include adsorption of molecules onto the sphere surface and the concentration change in the surrounding solution. A perturbation approach may be used to evaluate the resonance frequency shift of a WGM. In such an approach, the frequency shift δω is associated with the perturbation in the energy, δE, of a single-photon resonant state due to adsorption of a dielectric nanoparticle by

$$ℏ δω = δ E = \frac{1}{2} Re [ δp \cdot {E}^{*} ] , \qquad ( 1 )$$

where δp is the induced dipole moment in the nanoparticle, and E is local field within the original mode. The formulation was applied to a microsphere with a mono-layer coverage by protein molecules and a sphere with a single protein molecule adsorbed onto the equator. In the past, perturbation approach was applied to resonance modes in a spherical microcavity with reflective interior surface. (See, e.g., the articles, P. J. Wyatt, “Scattering of electromagnetic plane waves from inhomogeneous spherically symmetric objects”, Phys. Rev., Vol. 127, pp. 1837-1843 (1962), and D. Q. Chowdhury, S. C. Hill. P. W. Barber, “Morphology-dependent resonances in radially inhomogeneous spheres”, J. Opt. Soc. Am. A, Vol. 8, pp. 1702-1705 (1991). Formulas were obtained for the frequency shift due to a spatial change in the refractive index within the microcavity. These aforementioned formulations, however, do not allow one to evaluate the frequency shift due to changes in the medium surrounding the microsphere.

The use of a microspheres to detect a substance is described in U.S. patent application Ser. No. 10/096,333 (incorporated herein by reference), titled “DETECTING AND/OR MEASURING A SUBSTANCE BASED ON A RESONANCE SHIFT OF PHOTONS ORBITING A MICROSPHERE,” filed on Feb. 12, 2002, and listing Stephen Arnold and Iwao Teraoka as inventors, U.S. patent application Ser. No. 10/690,979 (incorporated herein by reference), titled “ENHANCING THE SENSITIVITY OF A MICROSPHERE SENSOR,” filed on Oct. 22, 2003 and listing Stephen Arnold, Iwao Teraoka and Frank Vollmer as inventors, U.S. patent application Ser. No. 10/735,247 (incorporated herein by reference), titled “USING A CHANGE IN ONE OR MORE PROPERTIES OF LIGHT IN ONE OR MORE MICROSPHERES FOR SENSING CHEMICALS USHC AS EXPLOSIVES AND POISON GASES,” filed on Dec. 12, 2003 and listing Stephen Arnold, Iwao Teraoka, Yoshiyuki Okamoto and Frank Vollmer as inventors, and U.S. Provisional Application Ser. No. 60/443,736 (incorporated herein by reference), titled “PERTURBATION OF OPTICAL CAVITIES BY DNA HYBRIDIZATION,” filed on Jan. 30, 2003 and listing Stephen Arnold, Iwao Teraoka and Frank Vollmer as inventors. As will be apparent to one skilled in the art, some of the methods and apparatus, or portions thereof, described in the foregoing applications may be used in concert with the present invention.

The perturbation exploited by various embodiments of the present invention is a small change in the refractive index. The change can be either within the sphere or in the surrounding medium. When applied to a uniform change in the refractive index of the surrounding medium, the formula gives the same result as the one obtained from the resonance formula for a homogeneous surrounding medium. Some embodiments of the present invention use the frequency shift, since it can be measured accurately (the resolution is better than ⅕ of the linewidth) and is relatively unaffected by auxiliary effects which are important in linewidth measurements, such as scattering and absorption by inhomogeneity of the sphere and the surrounding medium.

General formulas for the frequency shift for TE and TM modes derived in the '236 provisional are applied to (1) determine a uniform refractive index change in the medium surrounding one or more microspheres (caused by, for instance, a change in the surrounding fluid) in § 4.1 below, and (2) to determine a refractive index profile near the surface of one or more micropheres in § 4.2 below. Other parameters (such as a and m₁) are assumed not to change, unless otherwise mentioned. In the following, “l” may be used to denote an angular momentum quantum number; “r” may be used to denote a radial distance from the center of a microsphere, “a” may be used to denote the radius of a microsphere, “m₁” may be used to denote the refractive index of a microsphere, “m₂” may be used to denote the refractive index of medium surrounding a microsphere, and art-recognized symbols may be used to represent other quantities or attributes.

§ 4.1 Uniform Change in Refractive Index of the Surrounding Medium

§ 4.1.1 Derivation

In the following vacuum wavevector k is defined as k=2π/λ, where λ is the wavelength. Therefore, the relative frequency shift is related to the relative wavelength shift as δk/k₀=−δ λ/λ₀, where λ₀ is the wavelength at resonance before shift, and δλ is the wavelength shift. δλ may be measured by monitoring the intensity of light transmitting the fiber that is coupled to the microsphere (radius a, refractive index m₁) as the wavelength is scanned in a narrow range. The resonance wavelength is continuously followed.

For a uniform change Δm₂ in the exterior refractive index, the shift can be estimated using the resonance condition. The comparison of the latter result with the one to be obtained from the general formulas of the first-order perturbation validates the general formulas. In Eq. 11 of the '236 provisional that gives the resonance condition for the TE mode, change k₀ to k₀+Δk and change m₂ to m₂+Δm₂. Collecting the first-order terms, the fractional shift Δk/k₀ is calculated as:

$${( \frac{Δ k}{{k}_{0}} )}_{TE} = - \frac{{m}_{2} Δ {m}_{2}}{{m}_{1}^{2} - {m}_{2}^{2}} ⌊ \frac{l ( l + 1 )}{{( {m}_{2} {k}_{0} a )}^{2}} - 1 + \frac{1}{{m}_{2} {k}_{0} a} \frac{{χ}_{l}^{′}}{{χ}_{l}} - {( \frac{{χ}_{l}}{{χ}_{l}} )}^{2} ⌋ \\ = - \frac{{m}_{2} Δ {m}_{2}}{{m}_{1}^{2} - {m}_{2}^{2}} ⌊ \frac{{χ}_{l} + 1 {χ}_{l - 1}}{{χ}_{l}^{2}} - 1 ⌋ , \qquad ( 2 )$$

where Eq. C6 of the '236 provisional was used, and χₗ₋₁(z), χₗ(z), and χₗ₊₁(z), defined by Eq. 12 of the '236 provisional, are evaluated at z=m₂k₀a. For the TM mode, use of Eq. 15 of the '236 provisional leads to:

$${( \frac{Δ k}{{k}_{0}} )}_{TM} = - \frac{{m}_{2} Δ {m}_{2}}{{m}_{1}^{2} - {m}_{2}^{2}} \frac{\frac{l ( l + 1 )}{{( {m}_{2} {k}_{0} a )}^{2}} - 1 - \frac{1}{{m}_{2} {k}_{0} a} \frac{{χ}_{l}^{′}}{{χ}_{l}} - {( \frac{{χ}_{l}^{′}}{{χ}_{l}} )}^{2}}{\frac{l ( l + 1 )}{{( {m}_{1} {k}_{0} a )}^{2}} + {( \frac{{χ}_{l}^{′}}{{χ}_{l}} )}^{2}} . \qquad ( 3 )$$

Now the general formulas in the first-order perturbation are used to evaluate the fractional frequency shift. For the TE mode,

$$\begin{matrix}⟨ {k}_{0} \vert m δ m \vert {k}_{0} ⟩ = {m}_{2} Δ {{m}_{2} [ {B}_{l} ( {k}_{0} ) ]}^{2} {\int }_{a}^{∞} {[ {χ}_{l} ( {m}_{2} {k}_{0} r ) ]}^{2} ⅆ r \\ = {[ {B}_{l} ( {k}_{0} ) ]}^{2} {m}_{2} Δ {m}_{2} ⌊ - {χ}_{l}^{′2} + ( \frac{l ( l + 1 )}{{( {m}_{2} {k}_{0} a )}^{2}} - 1 ) {χ}_{l}^{2} + \frac{{χ}_{l} {χ}_{l}^{′}}{{m}_{2} {k}_{0} a} ⌋ ,\end{matrix} \qquad ( 4 )$$

where the same trick used in evaluating Eq. A9 of the '236 provisional was used to force the integral to converge. The term was neglected due to the upper limit of the integral. With Eq. 26 of the '236 provisional, the same equation as Eq. 2 is obtained.

For the TM mode, the formula given by Eq. 40 of the '236 provisional is used, because δm(r) remains finite at large r. The integrals are evaluated as follows:

$$\begin{matrix}⟨ {k}_{0} \vert {m}^{- 1} δ m \vert {k}_{0} ⟩ = {[ {A}_{l} ( {k}_{0} ) ]}^{2} \frac{a}{2} \frac{Δ {m}_{2}}{{m}_{2}} ⌊ - {χ}_{l}^{′2} + ( \frac{l ( l + 1 )}{{( {m}_{2} {k}_{0} a )}^{2}} - 1 ) {χ}_{l}^{2} + \frac{{χ}_{l} {χ}_{l}^{′}}{{m}_{2} {k}_{0} a} ⌋ , & ( 5 ) \\ ⟨ {k}_{0} \vert \frac{1}{{k}_{0}^{2} {m}^{2}} \frac{ⅆ ( δ m / m )}{ⅆ r} \frac{ⅆ}{ⅆ r} \vert {k}_{0} ⟩ = \frac{Δ {m}_{2}}{{k}_{0}^{2} {m}_{2}} {\int }_{0}^{∞} \frac{1}{{m}^{2}} {T}_{0} \frac{ⅆ {T}_{0}}{ⅆ r} δ ( r - a ) ⅆ r = {\frac{Δ {m}_{2}}{{k}_{0}^{2} {m}_{2}} [ {A}_{l} ( {k}_{0} ) ]}^{2} {χ}_{l} {χ}_{l}^{′} . & ( 6 )\end{matrix}$$

With Eqs. 27 and 40 of the '236 provisional, the same expression as Eq. 3 is obtained.

When k₀a >>1, use of Eqs. B5 and B7 of the '236 provisional simplifies Eqs. 2 and 3 to:

$$\begin{matrix}{( \frac{Δ k}{{k}_{0}} )}_{TE} ≅ - {\frac{{m}_{2} Δ {m}_{2}}{{m}_{1}^{2} - {m}_{2}^{2}} [ {( l + \frac{1}{2} )}^{2} - {( {m}_{2} {k}_{0} a )}^{2} ]}^{\frac{1}{2}} , & ( 7 ) \\ {( \frac{Δ k}{{k}_{0}} )}_{TM} ≅ - \frac{{m}_{2} Δ {m}_{2}}{{m}_{1}^{2} - {m}_{2}^{2}} \frac{2 {( l + \frac{1}{2} )}^{2} / {( {m}_{2} {k}_{0} a )}^{2} - 1}{{[ {( l + \frac{1}{2} )}^{2} - {( {m}_{2} {k}_{0} a )}^{2} ]}^{\frac{1}{2}} [ \frac{{( l + \frac{1}{2} )}^{2}}{{( {m}_{1} {k}_{0} a )}^{2}} + \frac{{( l + \frac{1}{2} )}^{2}}{{( {m}_{2} {k}_{0} a )}^{2}} - 1 ⌋} . & ( 8 )\end{matrix}$$

The shift occurs in the same direction to the two modes. For the first-order mode, 1≅m₁k₀α and these expressions are further simplified to:

$$\begin{matrix}{( \frac{Δ k}{{k}_{0}} )}_{TE} ≅ - \frac{{m}_{2} Δ {m}_{2}}{{( {m}_{1}^{2} - {m}_{2}^{2} )}^{\frac{3}{2}}} \frac{1}{{k}_{0} a} , \\ and & ( 9 ) \\ {( \frac{Δ k}{{k}_{0}} )}_{TM} ≅ - \frac{{m}_{2} Δ {m}_{2}}{{( {m}_{1}^{2} - {m}_{2}^{2} )}^{\frac{3}{2}}} ( 2 - \frac{{m}_{2}^{2}}{{m}_{1}^{2}} ) \frac{1}{{k}_{0} a} . & ( 10 )\end{matrix}$$

Thus, the ratio of the TM shift to the TE shift at k₀a>>1 is greater than unity for the first-order mode.

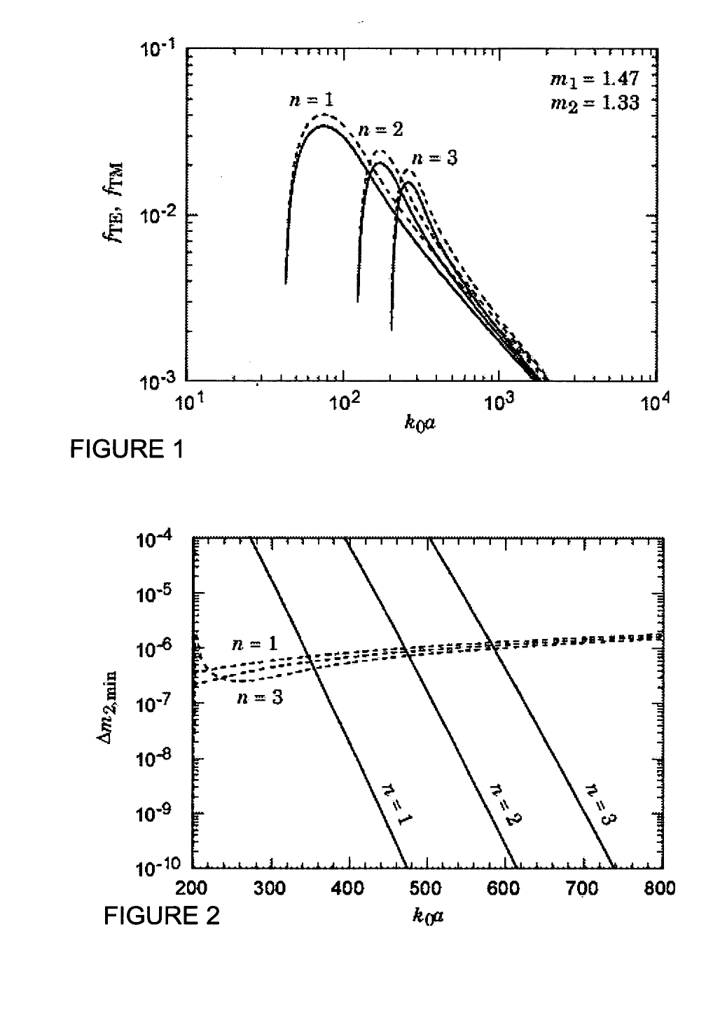

FIG. 1 shows a plot of sensitivity factors f_{TE}≡−(Δk/k₀)_{TE}/[m₂Δm₂(m₁²−m₂²)⁻¹] and f_{TM}≡−(Δk/k₀)_{TM}/[m₂Δm₂(m₁²−m₂²)⁻¹] for the first, second, and third-order modes (n=1, 2, and 3, respectively) as a function of size parameter k₀a. Equations 2 and 3 with m₁=1.47 (silica) and m₂=1.33 (water) were used for the calculation. At k₀a >>1, both f_{TE} and f_{TM} decrease as ˜(k₀a), in agreement with the asymptotic expressions (Eqs. 9 and 10). In this range, f_{TE}<f_{TM} for each mode. The higher-order mode (greater n) experiences a greater shift compared at the same k₀a, but the difference quickly disappears with an increasing k₀a. Both f_{TE} and f_{TM} peak at around k₀a≅76 for the first-order mode. This is due to a term neglected in Eqs. 7 and 8. The peak moves left and up, extending the nearly straight section, when m₁ is increased, thus more strongly confining the resonant photon by a greater contrast of refractive index.

For a given sphere with a/λ>>1, Δk/k₀ is proportional to the wavelength λ. The shorter the wavelength, the weaker is the effect by the surroundings. This fact is related to the penetration depth of the evanescent field from a high refractive index medium to a low refractive index medium when total internal reflection occurs.

Toward the low end of k₀a in the plot, the sensitivity factor is high, but the resonance peak may be too broad for any meaningful detection of Δm₂ by measuring Δk/k₀. The detection limit may be arbitrarily set to the width w of the peak (in terms of k₀a) which is given by:

$$w = \frac{2 {m}_{2}}{{m}_{1}^{2} - {m}_{2}^{2}} \frac{1}{{[ {χ}_{l} ( {m}_{2} {k}_{0} a ) ]}^{2}} , \qquad ( 11 )$$

for the TE mode. Then, the smallest Δm_{2,min} that can be detected is estimated as:

Δm_{2,min}=2/[k₀aχ₁²f_{TE}]=2/[k₀a(χ1+1χ₁₋₁−χ₁²)]. (12)

Likewise, for the TM mode,

$$Δ {m}_{2 , min} = \frac{2}{{k}_{0} a {χ}_{l}^{2} {f}_{TM}} \frac{1}{\frac{{( l + \frac{1}{2} )}^{2}}{{( {m}_{1} {k}_{0} a )}^{2}} + {( \frac{{χ}_{l}^{′}}{{χ}_{l}} )}^{2}} . \qquad ( 13 )$$

Solid lines in FIG. 2 show Δm_{2,min} for the first three orders of the TE mode. The first-order mode is the most sensitive compared at the same k₀a. At k₀a=400, Δm_{2,min} as small as 2×10⁻⁸ can be detected. Note that Δm_{2,min} decreases rapidly with an increasing k₀a, which may be due to smaller leakage of the photon energy.

There may be another limit on Δm_{2,min} due to the laser linewidth or the source wavelength fluctuations, whichever is greater. In the study of protein adsorption, a DFB laser (λ=1.34 μm) was used. (See, e.g., the paper, F. Vollmer, D. Braun, A. Libchaber, M. Khoshsima, I. Teraoka, S. Arnold, “Protein detection by optical shift of a resonant microcavity”, Appl. Phys. Lett., Vol. 80, pp. 4049-4057 (2002).) The source wavelength fluctuations may surpass the laser linewidth. The fluctuations were about 10⁻⁵ nm, which translates into Δk/k₀˜10⁻⁸. Dashed lines in FIG. 2 represent Δm_{2,min} imposed by this restriction. They are nearly flat between ˜10⁻⁶ and ˜10⁻⁷ in the range of the plot. It is now apparent that the second limit may restrict the detection limit. Accordingly, it may be advisable to decrease the source fluctuations.

§ 4.1.2 Exemplary Apparatus

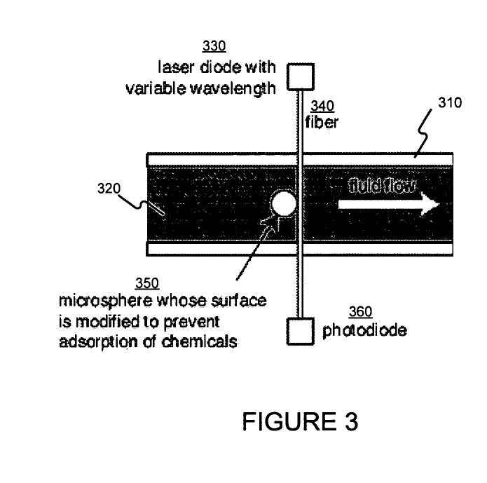

FIG. 3 is an exemplary apparatus that may be used to detect a change in the refractive index in the medium surrounding microsphere 350. The micosphere 350 is optically coupled with fiber 340. A laser 330, such as a variable wavelength laser diode for example, may be used to inject light into the fiber 340. A detector 360, such as a photodiode for example, may be used to detect properties of light in the fiber 340. As shown, the microsphere 350 may be provided in fluid passage 310 through which fluid (eluent) 320 flows.

This apparatus may be used to detect a change in the refractive index in the medium surrounding the microsphere 350. Equations 9 and 10 above indicate that the relative shift, Δk/k₀ is proportional to Δm₂. A typical situation might be a detector used in liquid chromatography to detect a refractive index (RI detector). The microsphere 350 may be placed in a fluid constantly washed by the eluent. Usually, a constant mobile phase is flowing around the microsphere 350. As eluent 320 containing an analyte reaches the microsphere 350, the resonance starts to shift. When the surrounding fluid returns to the mobile phase, the shift returns to zero. The height of the shift is proportional to the concentration of the analyte in the eluent. This example assumes a spatially uniform refractive index.

For RI sensing, the surface of the microsphere 350 should be modified to avoid adsorption of a chemical. For instance, reaction of the silanols on the surface of silica (or hydroxyls on the surface of other oxides) with octyldimethylchlorosilane changes the surface from silanol to octyl (usually referred to as C8 in HPLC). In organic solvent, such a surface will repel most of the analytes.

A computing device (not shown), such as a personal computer for example, may function to (a) control the light source 330, (b) record shifts of some property of light, (c) determine a (change in) refractive index, and/or (d) identify an analyte using the determined (change in) refractive index.

§ 4.1.3 Exemplary Method

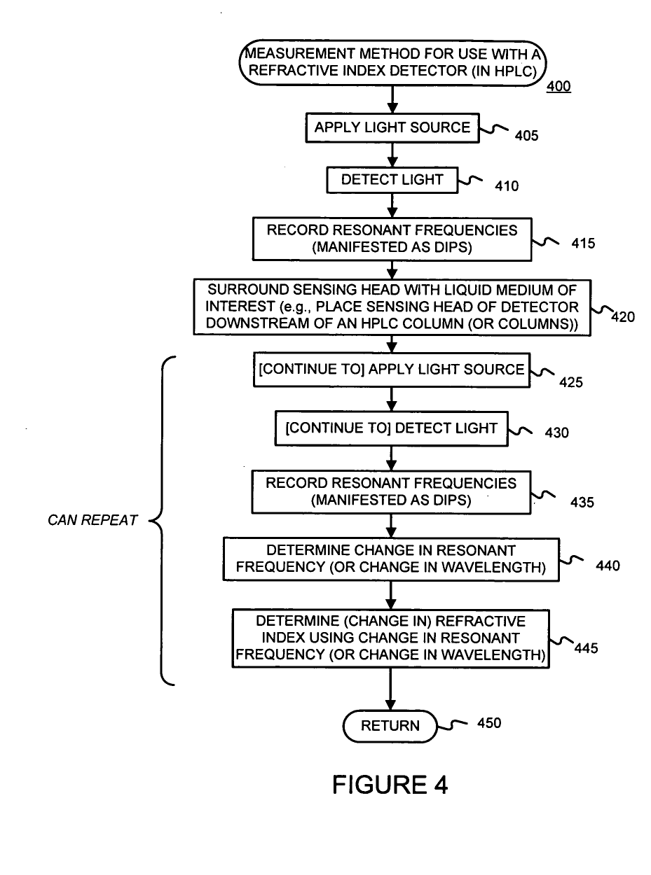

FIG. 4 is a flow diagram of an exemplary method 400 that may be used to detect a refractive index of an analyte in a manner consistent with the present invention. A light source (e.g., 330) is applied (Block 405) and light is detected (e.g., with detector 360) (Block 410). One or more resonance frequencies are recorded. (Block 415) The sensing head (e.g., 350) is then surrounded with a liquid of interest (e.g., eluent containing analyte 320). (Block 420) A light source is again (or continuously) applied (Block 425) and light is again (or continues to be) detected (Block 430). One or more resonance frequencies are again (or continuously) recorded. (Block 435) The change in resonance frequency (or change in wavelength) is then determined. (Block 440) A change in refractive index (e.g., of the eluent to the analyte) may then be determined using the change in resonant frequency. (Block 445)

§ 4.2 Depletion of Refractive Index at the Interface

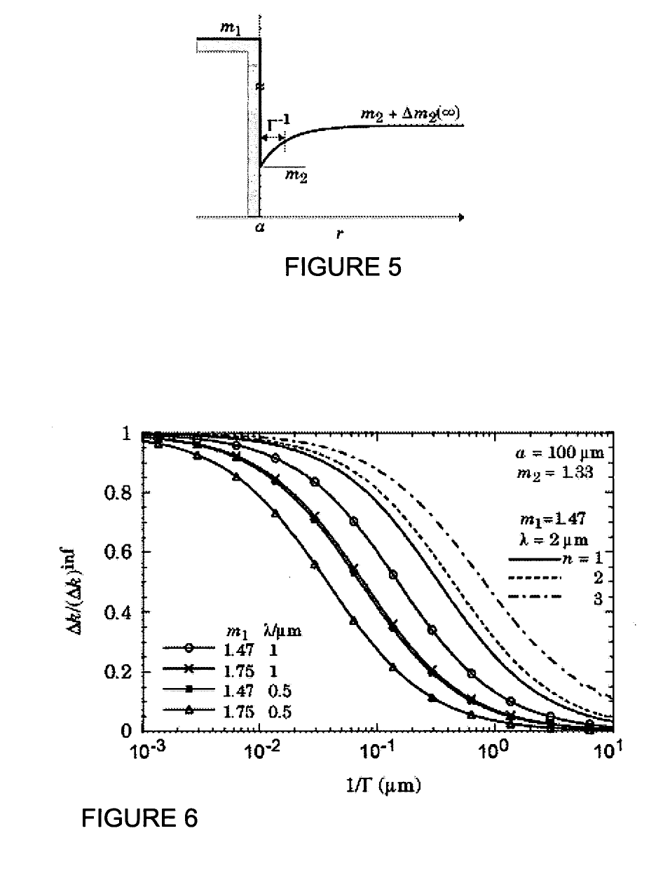

A change in the profile of the refractive index in the medium surrounding the microsphere may be generated. FIGS. 5 and 6 illustrate the profile. RI is plotted as a function of the distance from the microsphere surface. Since how Δk/k₀ depends on the profile is different for different wavelengths of light, mode orders (n), and refractive indices of the microsphere, this dependence can be used to determine the profile.

§ 4.2.1 Derivation

Using different values of k₀a, especially λ, enables WGM to be a sensor for the refractive index profile of the surrounding medium near the surface. When the exterior medium is a solution of macromolecules or a suspension of particles, the refractive index of the solution may change as a function of the distance from the sphere surface. If the solute has a positive differential refractive index and does not interact with the microsphere except steric hindrance, the refractive index may have a profile as depicted in FIG. 5. Although this mean-field refractive index profile may not be valid for suspension of large solid particles with a large refractive index difference, it will nonetheless be a good approximation for solutions of macromolecules and suspension of swollen gel particles and vesicles.

It is convenient to separate Δm₂(r) into two parts: Δm₂(r)=Δm₂(∞)−[Δm₂(∞)−Δm₂(r)]. In the first-order perturbation, each term gives an independent frequency shift. Thus,

$$\frac{Δ k}{{k}_{0}} = {( \frac{Δ k}{{k}_{0}} )}^{inf} - {( \frac{Δ k}{{k}_{0}} )}^{dep} , \qquad ( 14 )$$

where the first term is given by Eqs. 2 and 3 (Δm₂(∞) in place of Δm₂) for the TE and TM modes, respectively. The second term decreases rapidly to zero at long distances. For the TE mode,

$${( \frac{Δ k}{{k}_{0}} )}_{TE}^{dep} = - \frac{⟨ {k}_{0} \vert {m}_{2} [ Δ {m}_{2} ( ∞ ) ∼ Δ {m}_{2} ( r ) ] \vert {k}_{0} ⟩}{⟨ {k}_{0} \vert {m}_{2}^{2} \vert {k}_{0} ⟩} \\ = - \frac{{m}_{2} {\int }_{a}^{∞} {[ {χ}_{l} ( {m}_{2} {k}_{0} r ) ]}^{2} [ Δ {m}_{2} ( ∞ ) - Δ {m}_{2} ( r ) ] ⅆ r}{{( a / 2 ) [ {χ}_{l} ( {m}_{2} {k}_{0} a ) ]}^{2} ( {m}_{1}^{2} - {m}_{2}^{2} )} . \qquad ( 15 )$$

For the TM resonance, (Δk/k₀)_{TM}^{dep} can be calculated similarly by using Eq. 41 of the '236 provisional.

Numerical calculation was done for a profile Δm₂(r) that changes as:

Δm₂(r)/Δm₂(∞)=1−exp[−Γ(r−a)], (16)

for r>α. The lines in FIG. 6 are plots of Δk of the first-order TE mode, reduced by its (Δk)^{inf}, for a=100 μm and m₂=1.33 but various values of m₁, λ, and n. Comparing the five solid lines, note that a shorter wavelength or a microsphere with a greater refractive index is less sensitive to a deeper depression. The higher-order mode can explore a deeper depression. The values of parameters used in the figure are currently accessible. Use of microsphere sensors of different λ and m₁ and analysis of various orders of resonance will allow the depth of depression and its profile to be estimated. In a solution of macromolecules, for instance, the molecular weight distribution may be determined just by dipping the sensor heads into the solution. A more elaborate expression for Δm₂(r) may be necessary for that purpose.

§ 4.2.2 Exemplary Apparatus

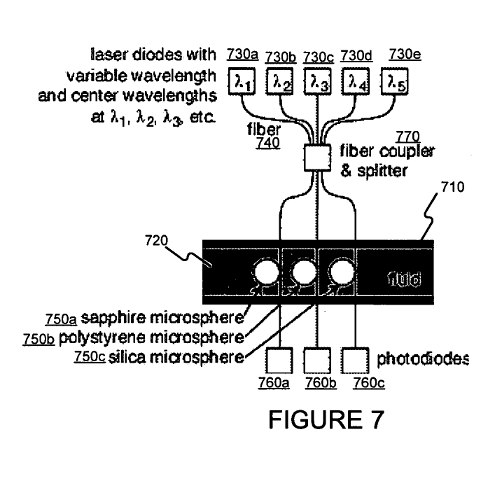

FIG. 7 illustrates an exemplary measurement system that allows a scan of the resonance spectrum having resonances coming from different mode orders to be performed. Analysis of all of the information obtained may be used to determine the refractive index profile. One or more microspheres 750 are optically coupled with one or more fibers 740. One more lasers 730, each having a different wavelength may be used to inject light into the fibers 740 via fiber coupler and splitter 760. One or more detectors 760, such as photodiodes for example, may be used to detect properties of light in the fibers 740. As shown, the microspheres 750 may be provided in fluid passage 710 through which fluid (eluent) 720 flows. Note that when different components (e.g., lasers, microspheres, etc.) are used, certain operations can occur in parallel. Alternatively, or in addition, operations can be performed in series. For example, a first laser wavelength may be injected into a first fiber coupled with a first microsphere and a first sensor while a second (and perhaps further) laser wavelength may be injected into a second (and perhaps further) fiber coupled with a second (and perhaps further) microsphere and a second (and perhaps further) sensor. Alternatively, or in addition, a first laser wavelength may be injected into a first fiber coupled with a first microsphere and a first sensor at a first time, and a different laser wavelength may be injected into the first fiber coupled with the first microsphere and the first sensor at a later time, and so on.

The center wavelength of the light sources 730 may be, for example, blue, red, 980 nm, 1350 nm, 1550 nm, etc. The different microspheres 750 may be of different materials, such as silica, polystyrene, sapphire, etc.

A computing device (not shown), such as a personal computer for example, may function to (a) control the light sources 730, (b) record shifts of some property of light, (c) determine a refractive index profile, and/or (d) identify an analyte using the determined refractive index profile.

§ 4.2.3 Exemplary Method

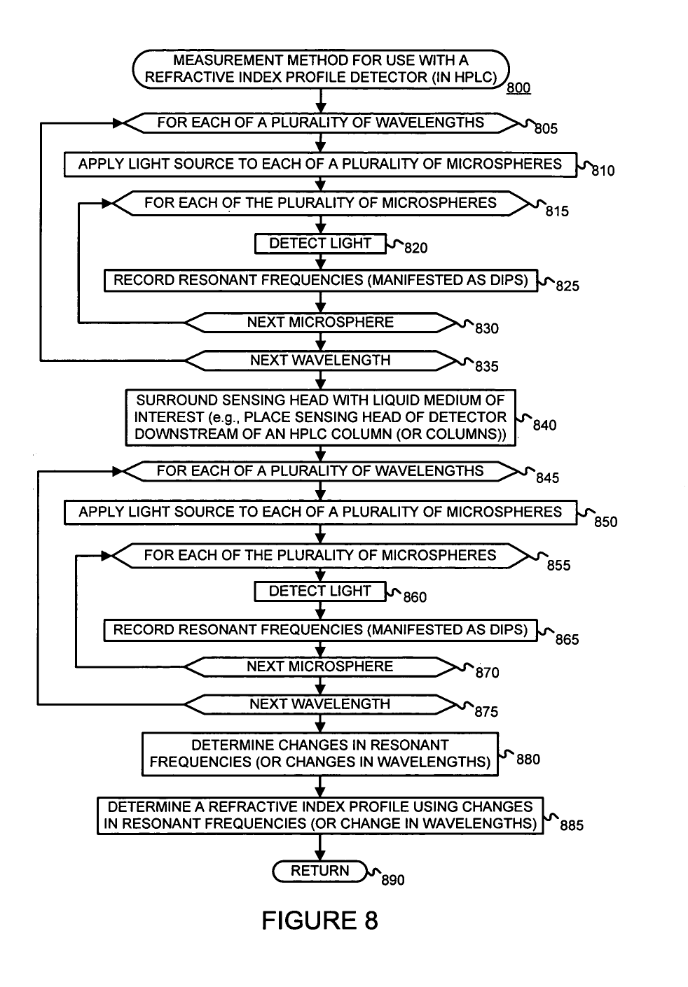

FIG. 8 is a flow diagram of an exemplary method 800 that may be used to determine a refractive index profile of an analyte in a manner consistent with the present invention. As indicated by loop 805-835 a number of acts are performed for each of a plurality of wavelengths. (Recall, e.g., laser sources 730.) The light source at the wavelength is applied to each of a plurality of microspheres (e.g., 750). (Block 810) As indicated by loop 815-830 for each of the plurality of microspheres, light is detected (e.g., with 760) (Block 820), and one or more resonant frequencies are recorded (Block 825). The sensing head(s) (e.g., 750) are then surrounded with a liquid of interest (e.g., eluent containing analyte 720). (Block 840)

As indicated by loop 845-875 a number of acts are performed for each of a plurality of wavelengths. The light source at the wavelength is applied (or continues to be applied) to each of a plurality of microspheres. (Block 850) As indicated by loop 855-870, for each of the plurality of microspheres, light is (or continues to be) detected (Block 860), and one or more resonant frequencies are recorded (Block 865). Changes in the resonant frequencies (or changes in the wavelength are determined. (Block 880) A refractive index profile is then determined using the changes in the resonant frequencies for various wavelengths, for various microspheres, and/or for various {wavelength,microsphere} pairs. (Block 885) This determination may be made using the results of test for many polymer standards of a narrow molecular weight distribution. FIG. 6 shows the expected Δλ/λ for a profile shown in FIG. 5. The determination of a refractive index profile using changes in resonant frequencies is a reverse operation of this.

If the method of FIG. 8 is practiced with the apparatus of FIG. 7, five light sources and three microspheres may be used for example. The microspheres are made of transparent materials of different refractive indices, for instance, silica, polystyrene, and sapphire.

§ 5. Conclusions

The embodiment of the present invention discussed in § 4.1 above can be used to construct tiny refractive index detectors that may replace bulky detector widely used in liquid chromatography. The embodiment of the present invention discussed in § 4.2 allows small instruments to measure size distribution of suspensions and molecular weight distribution of polymers. The measurement may be instantaneous. A polymer with a higher molecular weight may have a depression in the refractive index over a longer distance compared with a polymer with a lower molecular weight. A polymer with a different molecular weight distribution has a different refractive index profile near the surface.

What is claimed is:

1. A method for detecting a refractive index of an analyte, the method comprising:
a) applying a light source to a fiber optically coupled with a microsphere;
b) detected light from the fiber;
c) recording one or more resonance frequencies observed in the detected light;
d) surrounding the microsphere with the analyte;
e) applying the light source to the fiber optically coupled with the microsphere;
f) detected light from the fiber;
g) recording one or more resonance frequencies observed in the detected light;
h) determining a change in one or more resonance frequencies; and
i) determining change in a refractive index using the change in resonant frequency.

2. The method of claim 1 wherein the microsphere is silica.

3. The method of claim 2 wherein a surface of the microsphere is octyl.

4. The method of claim 2 wherein the surface of the microsphere has been treated with octyldimethylchlorosilane.

5. The method of claim 1 wherein the microsphere is polystyrene.

6. The method of claim 1 wherein the microsphere is sapphire.

7. The method of claim 1 wherein a surface of the microsphere has been modified to avoid adsorption of the analyte.

8. The method of claim 1 further comprising:
j) identifying the analyte using the determined change in refractive index.

9. Apparatus for detecting a refractive index of an analyte, the method comprising:
a) an optical fiber optically coupled with a microsphere;
b) a light source optically coupled with the optical fiber;
c) a light detector optically coupled with the optical fiber;
d) means for recording one or more resonance frequencies observed in the detected light;
e) means for surrounding the microsphere with the analyte;
f) control means for
i) controlling the light source to apply light to the optical fiber,
ii) controlling the light detector to detected light from the optical fiber, and
iii) controlling the means for recording to recording one or more resonance frequencies observed in the detected light, both before and after the microsphere is surrounded with the analyte;
g) means for determining a change in one or more resonance frequencies; and
h) means for determining change in a refractive index using the change in resonant frequency.

10. The apparatus of claim 9 wherein the microsphere is silica.

11. The apparatus of claim 10 wherein a surface of the microsphere is octyl.

12. The apparatus of claim 10 wherein the surface of the microsphere has been treated with octyldimethylchlorosilane.

13. The apparatus of claim 9 wherein the microsphere is polystyrene.

14. The apparatus of claim 9 wherein the microsphere is sapphire.

15. The apparatus of claim 9 wherein a surface of the microsphere has been modified to avoid adsorption of the analyte.

16. The apparatus of claim 9 further comprising:
i) means for identifying the analyte using the determined change in refractive index.

17. A method for determining a refractive index profile of an analyte, the method comprising:
a) for each of a plurality of wavelengths,
i) applying a light source at the wavelength to each of a plurality of microspheres and for each of the plurality of microspheres,
A) detecting light, and
B) recording one or more resonant frequencies are recorded;
b) surrounding the microspheres with the analyte;
c) for each of a plurality of wavelengths,
i) applying a light source at the wavelength to each of the plurality of microspheres and for each of the plurality of microspheres,
A) detecting light, and
B) recording one or more resonant frequencies are recorded;
d) determining changes in the resonant frequencies associated with each of a plurality of wavelength, microsphere pairs; and
e) determining a refractive index profile using the changes in the resonant frequencies.

18. The method of claim 17 wherein at least one of the microspheres is silica.

19. The method of claim 18 wherein a surface of the at least one microsphere is octyl.

20. The method of claim 18 wherein the surface of the at least one microsphere has been treated with octyldimethylchlorosilane.

21. The method of claim 17 wherein at least one of the microspheres is polystyrene.

22. The method of claim 17 wherein at least one of the microspheres is sapphire.

23. The method of claim 17 wherein a surface of each of the microspheres has been modified to avoid adsorption of the analyte.

24. The method of claim 17 wherein the plurality of wavelengths include about 980 nm, about 1350 nm, and about 1550 nm.

25. The method of claim 17 further comprising:
f) identifying the analyte using the determined refractive index profile.

26. Apparatus for determining a refractive index profile of an analyte, the apparatus comprising:
a) a plurality of optical fibers, each optically coupled with a microsphere;
b) means for sourcing light at a plurality of wavelengths with the plurality of optical fibers;
c) means for detecting light from the plurality of optical fibers;
d) means for recording one or more resonance frequencies observed in the detected light;
e) means for surrounding the plurality of microspheres with the analyte;
f) control means for
i) controlling the means for sourcing light at a plurality of wavelengths to apply light at a plurality of wavelengths to the plurality of optical fibers,
ii) controlling the means for detecting to light from the plurality of optical fibers, and
iii) controlling the means for recording to recording a profile of one or more resonance frequencies associated with each of a plurality of wavelength, microsphere pairs,
both before and after the plurality of microspheres is surrounded with the analyte;
d) determining changes in the resonant frequencies associated with each of a plurality of wavelength, microsphere pairs; and
e) means for determining a refractive index profile using the changes in the resonant frequencies associated with the plurality of wavelength, microsphere pairs.

27. The apparatus of claim 26 wherein at least one of the microspheres is silica.

28. The apparatus of claim 27 wherein a surface of the at least one microsphere is octyl.

29. The apparatus of claim 27 wherein the surface of the at least one microsphere has been treated with octyldimethylchlorosilane.

30. The apparatus of claim 26 wherein at least one of the microspheres is polystyrene.

31. The apparatus of claim 26 wherein at least one of the microspheres is sapphire.

32. The apparatus of claim 26 wherein a surface of each of the microspheres has been modified to avoid adsorption of the analyte.

33. The apparatus of claim 26 wherein the plurality of wavelengths include about 980 nm, about 1350 nm, and about 1550 nm.

34. The apparatus of claim 26 further comprising:
f) means for identifying the analyte using the determined refractive index profile.
